(19) United States
(12) Patent Application Publication
(10) Pub. No.: US 2004/0250963 A1
(43) Pub. Date: Dec. 16, 2004

(54) Non-pull cord operated multi-layer venetian blind

(75) Inventor: Pey-Son Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: CHING FENG BLINDS IND. CO., LTD.

(21) Appl. No.: 10/458,232

(22) Filed: Jun. 11, 2003

(51) Int. Cl. E06B 3/48

(52) U.S. Cl. 160/84.03

(57) ABSTRACT

A non-pull cord operated multi-layer Venetian blind comprises an upper beam, a lower beam, and an intermediate beam with upper and lower blind bodies of different materials and patterns attached thereto. The upper and lower blind bodies are made up of upper and lower slats with upper and lower cord passage holes disposed at both left and right sides thereof respectively; and the upper, intermediate, and lower beams are equipped with upper, intermediate, and lower slide guide pieces thereof respectively for a retaining cord to be guided smoothly there-through. Both ends of the retaining cord, led through the upper beam and the upper cord-passage holes thereof and first crisscrossed at the intermediate beam therein, are guided through the lower cord-passage holes thereof and crisscrossed again at the lower beam therein before extending transversely there-from via outer slide guide pieces of locating caps stopped at both ends of the lower beam to be tied up to fixing means suspended beneath the lower beam thereof. Thus, the retaining cord is smoothly guided with turning points thereof in sliding abutment against projecting arc facets of the slide guide pieces thereof so as to reduce the frictional coefficient of each turning point thereof when the Venetian blind thereof is repeatedly pushed upwards or drawn downwards, ensuring the smooth operation of the non-pull cord multi-layer Venetian blind thereof

### BACKGROUND OF THE INVENTION

The present invention is related to a non-pull cord operated multi-layer Venetian blind, comprising an upper beam, a lower beam, and an intermediate beam with upper and lower blind bodies of different materials and patterns attached thereto. A retaining cord is wound and led out from the upper beam at both ends thereof which are guided through the upper blind body and crisscrossed at the intermediate beam therein before extending downwards through the lower blind body and crisscrossed again at the lower beam therein. Both ends of the retaining cord are led through locating caps stopped at both ends of the lower beam and tied up to fixing means suspending beneath the lower beam thereof; whereby, via upper, intermediate, lower, and outer slide guide pieces, the retaining cord is smoothly guided there-through with turning points thereof in sliding abutment against projecting arc facets of the slide guide pieces thereof so as to reduce the frictional coefficient of each turning point thereof when the Venetian blind thereof is repeatedly pushed upwards or drawn downwards, ensuring the smooth operation of the non-pull cord multi-layer Venetian blind thereof.

Please refer to FIG. 1. A conventional non-pull cord operated Venetian blind is mainly made up of a Venetian blind 30 having an upper beam 31, a lower beam 32, a blind body 33 securely attached to the upper and lower beams 31, 32 there-between, and a left and a right lateral frames 34, 35 with slide grooves 341, 351 vertically defined therein respectively disposed at both sides of the blind body 33 thereof. A pair of pull springs 311 are securely fixed to the inner left and right sides of the upper beam 31, to which left and right retaining cords 36 are securely joined at one ends thereof. The other ends of the left and right retaining cords 36, respectively led downwards through the blind body 33, are passed through the upper surface of the lower beam 32 thereof and crisscrossed therein before extending in opposite directions out from both ends of the lower beam thereof and fixed to the bottom sides of the slide grooves 341, 351 of the left and right lateral frames 34, 35 thereof respectively.

There are some drawbacks to such conventional non-pull cord Venetian blind. The left and right retaining cords 36 are securely fixed to the pull springs 311 at one ends thereof, which can easily get loose due to the elastic fatigue of the pull springs 311 when the blind body 10 is repeatedly drawn downwards or pushed upwards, hindering the smooth operation and reducing the using lifespan of the non-pull cord Venetian blind thereof. Second, the left and right retaining cords 36 are led out from the upper beam 31, through the blind body 33, and finally into the lower beam 32 to go out in crisscross from both ends of the lower beam 32 to be located at the bottom sides of the left and right lateral frames 34, 35 wherein at least three turning points are formed for each retaining cord 36 therewith. Without any slide guiding design, the turning points of the left and right retaining cords 36 are in constant friction with the upper and lower beams 31, 32 thereof which in a long time may wear out or even break the retaining cords 36 thereof, hindering the smooth movement of non-pull cord Venetian blind in operation. Third, the left and right lateral frames 34, 35 are required for the location of the left and right retaining cords 36 at the bottom sides thereof, uneconomically increasing the cost of materials and the time of assembly.

### SUMMARY OF THE PRESENT INVENTION

It is, therefore, the primary purpose of the present invention to provide a non-pull cord multi-layer Venetian blind, comprising an upper beam, a lower beam, and an intermediate beam with upper and lower blind bodies of different materials and patterns attached thereto wherein a retaining cord is directly wound and led out of the upper beam at both ends thereof rather than attached to pull springs so that the retaining cord can extend straight downwards without getting loose when the upper and lower blind bodied thereof are repeated drawn up or down.

It is, therefore, the secondary purpose of the present invention to provide a non-pull cord multi-layer Venetian blind wherein the upper, intermediate, and lower beams are equipped with upper, intermediate, and lower slide guide pieces thereof respectively, via which the retaining cord is smoothly guided there-through with turning points thereof in sliding abutment against projecting arc facets of the slide guide pieces thereof so as to reduce the frictional coefficient of each turning point thereof when the Venetian blind thereof is repeatedly pushed upwards or drawn downwards, ensuring the smooth operation of the non-pull cord multi-layer Venetian blind thereof in practical use.

It is, therefore, the third purpose of the present invention to provide a non-pull cord multi-layer Venetian blind wherein both ends of the retaining cord are wound and tied up to fixing means suspended beneath the lower beam thereof for location, economically reducing the cost of materials and the time of assembly as well.

### BRIEF DESCRIPTION OF THE DRAWINGS

FIG. 1 is a sectional view of a conventional non-pull cord operated Venetian blind in assembly.

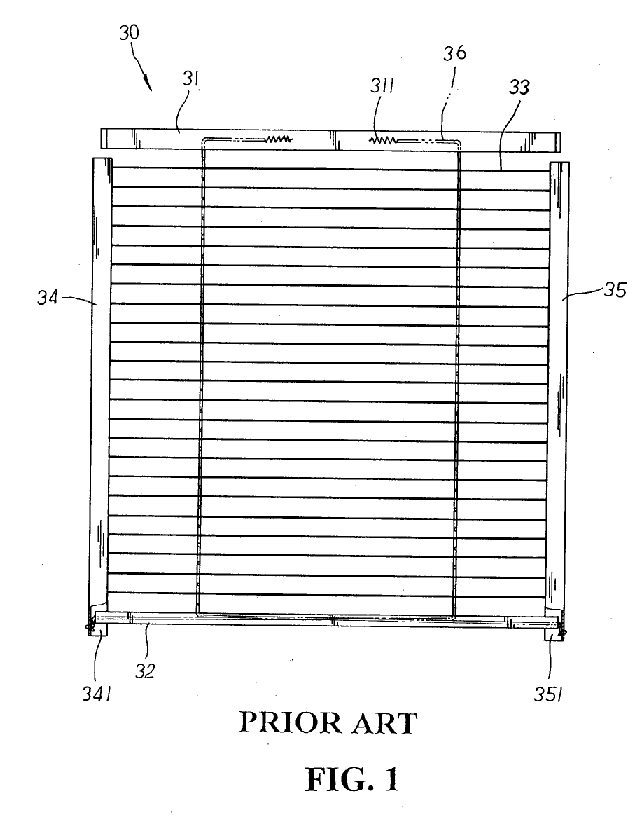

FIG. 2 is a perspective exploded view of the present invention.

FIG. 3 is a sectional view of the present invention in assembly.

FIG. 4 is a diagram showing the present invention in practical use.

FIG. 5 is a partially sectional view of the present invention in practical use.

FIG. 6 is a partial sectional view of another embodiment of the present invention.

FIG. 7 is a sectional view of another embodiment of the present invention in assembly.

FIG. 8 is a sectional view of a third embodiment of the present invention in assembly.

FIG. 9 is a sectional view of a fourth embodiment of the present invention in assembly.

### DETAILED DESCRIPTION OF THE PREFERRED EMBODIMENTS

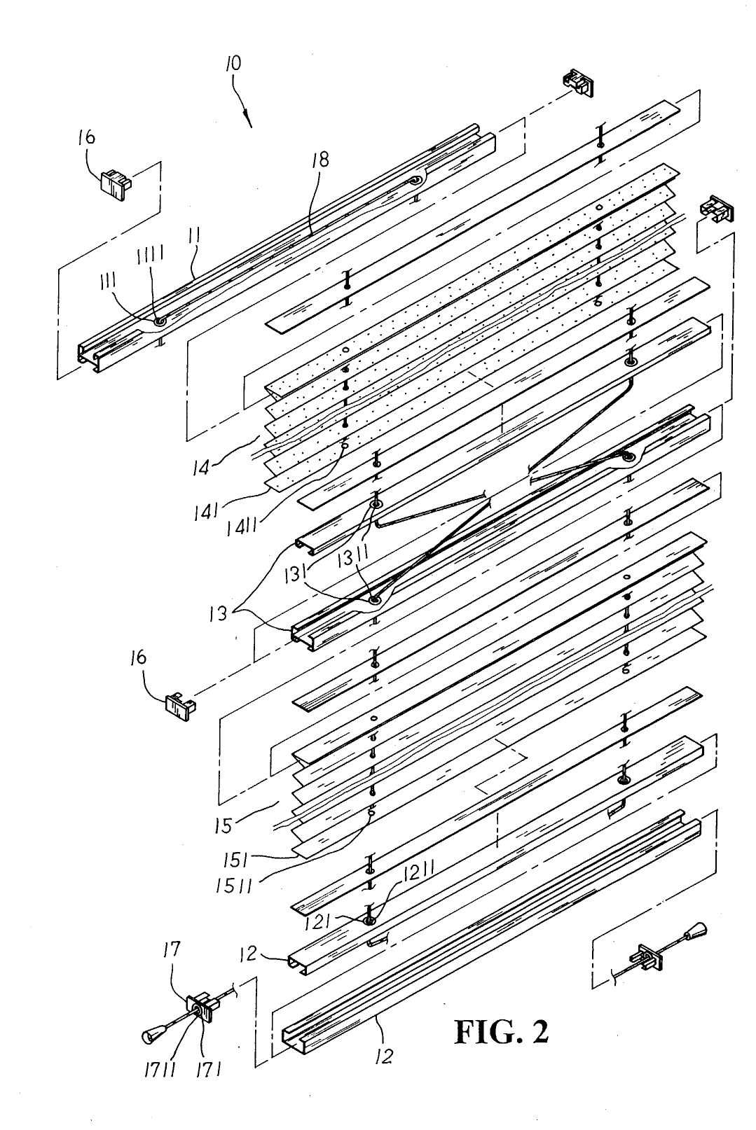

Please refer to FIGS. 2. The present invention is related to a non-pull cord operated multi-layer Venetian blind, comprising a multi-layer Venetian blind 10 made up of an upper beam 11, a lower beam 12, and an intermediate beam 13 with an upper blind body 14 and a lower blind body 15 of different materials and patterns attached thereto respectively. The upper and lower blind bodies 14, 15 are made up of a plurality of upper and lower slats 141, 151 with each upper slat 141 thereof having upper cord passage holes 1411 and each lower slat 15 thereof equipped with lower cord passage holes 1511 disposed at both left and right sides thereof respectively. A fixing cap 16 is adapted to both ends of the upper and intermediate beams 11, 13 thereof respectively, while a locating cap 17 is stopped at both ends of the lower beam 12 thereof respectively. A pair of opposite upper slide guide pieces 111 and a pair of opposite lower slide guide pieces 121 are correspondingly disposed at the lower surface of the upper beam 11 and the upper surface of the lower beam 12 thereof respectively, while opposite intermediate slide guide pieces 131 are provided at both the upper and lower surfaces of the intermediate beam 13 thereof. The locating caps 17 also have outer slide guide pieces 171 disposed thereon. The upper, lower, intermediate, and outer slide guide pieces 111, 121, 131, 171 thereof, each having projecting arc facets disposed at the upper and lower inner edges thereof, are respectively equipped with upper, lower, intermediate, and outer through holes 1111, 1211, 1311, 1711 at the center thereof for a retaining cord 18 to be guided smoothly there-through.

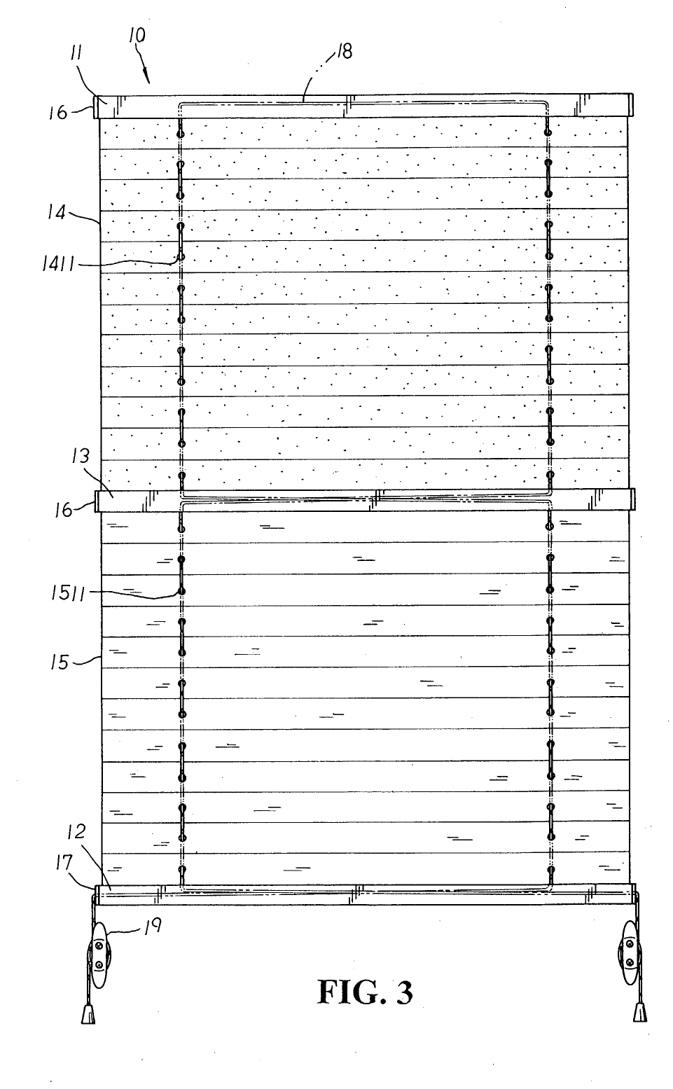

Please refer to FIG. 3. In assembly, the retaining cord 18 is led through the upper through holes 1111 of the upper slide guide pieces 111 thereof by both ends and guided downwards to pass consecutively through the upper cord-passage holes 1411 of the upper slats 141 thereof Both ends of the retaining cord 18 are led through the intermediate through holes 1311 of the intermediate slide guide pieces 131 disposed at the upper surface of the intermediate beam 13 thereof to be crisscrossed and extended in opposite directions at the intermediate beam 13 therein before going out there-from via the intermediate slide guide pieces 131 disposed at the lower surface of the intermediate beam 13 thereof. The crisscrossed retaining cord 18 is led downwards through the lower cord-passage holes 1511 of the lower slats 151 at both ends thereof and passed through the lower through holes 1211 of the lower slide guide pieces 121 thereof to be adapted at the lower beam 12 therein. Both ends of the retaining cord 18 thereof are crisscrossed again at the lower beam 12 therein before extending transversely in opposite directions to come out of the locating caps 17 stopped at both ends of the lower beam 12 via the outer through holes 1711 of the outer slide guide pieces 171 thereof Both ends of the retaining cord 18 extending out of the locating caps 17 thereof are securely wound up to fixing means 19 and suspended downwards beneath the lower beam 12 as shown in FIG. 3.

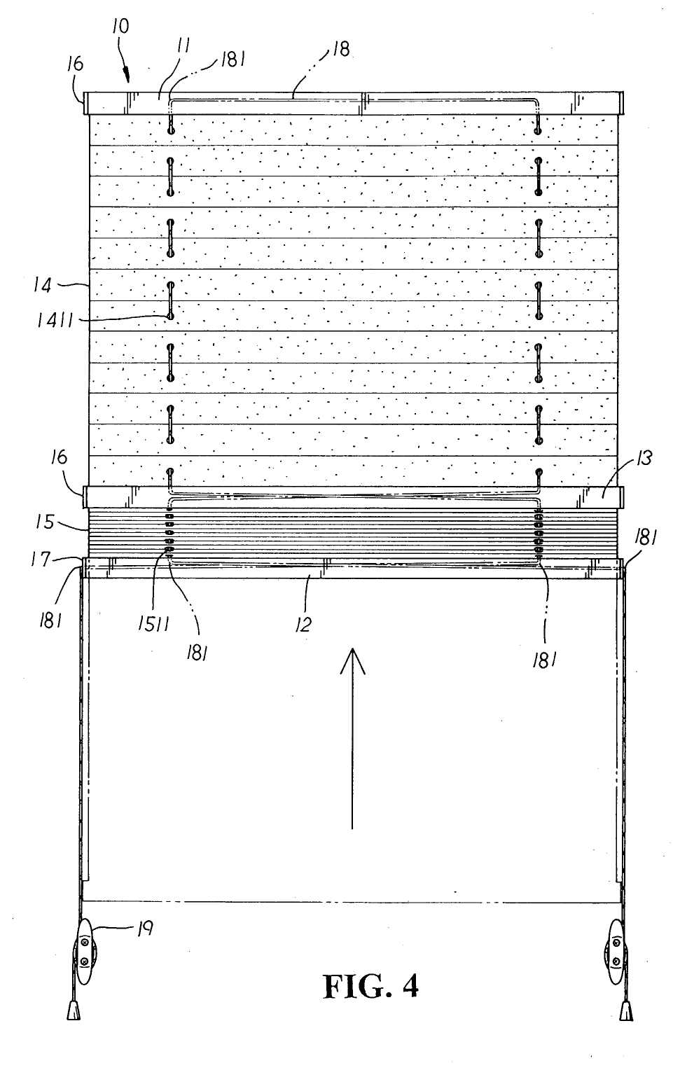

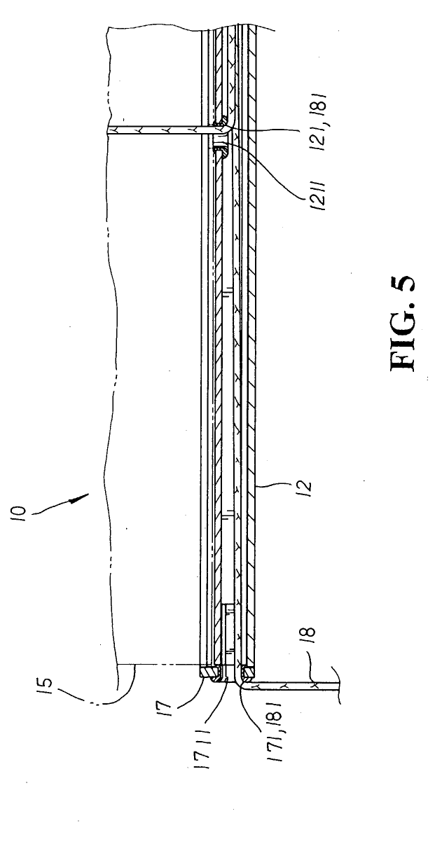

Please refer to FIG. 4. In practical use, the upper and lower blind bodies 14, 15 are pushed upwards or drawn downwards to gather up or unfold the multi-layer Venetian blind 10 thereof. Meanwhile, the retaining cord 18 is smoothly guided through the upper, intermediate, lower, and outer through holes 1111, 1211, 1311, 1711 thereof respectively with turning points 181 thereof in sliding abutment against the projecting arc facets of the upper, intermediate, lower, and outer slide guide pieces 111, 121, 131,171 thereof as shown in FIG. 5. Thus, when the Venetian blind 10 thereof is repeatedly pushed upwards or drawn downwards, the frictional coefficient of each turning points 181 of the retaining cord 18 is reduced to the minimum to ensure the smooth operation of the non-pull cord multi-layer Venetian blind thereof.

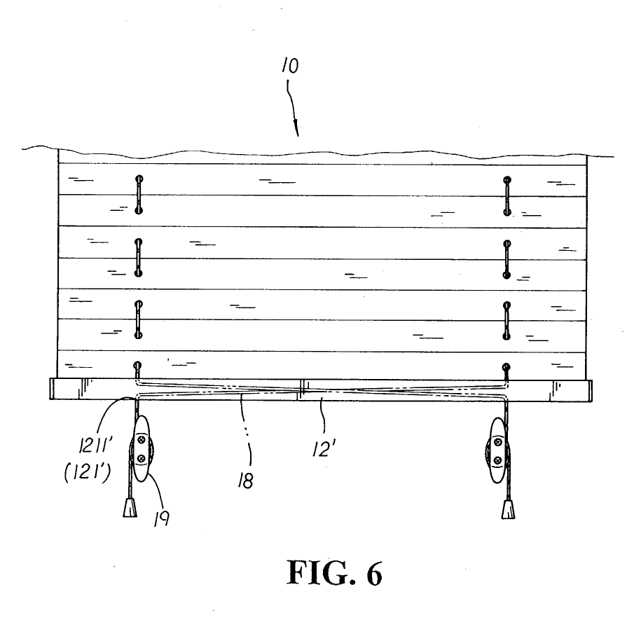

Please refer to FIG. 6. The multi-layer Venetian blind 10 can also have a lower beam 12′ with two pairs of opposite lower slide guide pieces 121′ and lower through holes 1211′ correspondingly disposed at the upper and lower surfaces thereon. Both ends of the retaining cord 18, led into the lower beam 12′ via the lower slide guide pieces 121′ disposed at the upper surface thereof and extended transversely in opposite directions, are directly passed through the slide guide pieces 121′ disposed at the lower surface of the lower beam 12′ to be tied up to the fixing means 19 respectively for location and suspended downwards under the lower beam 12′ thereof.

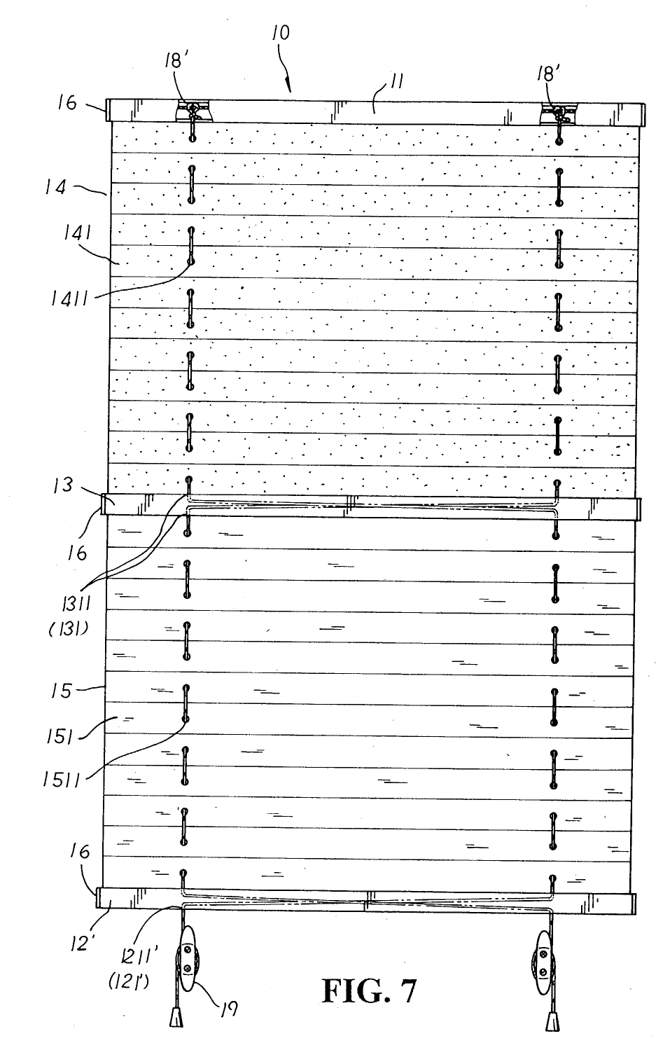

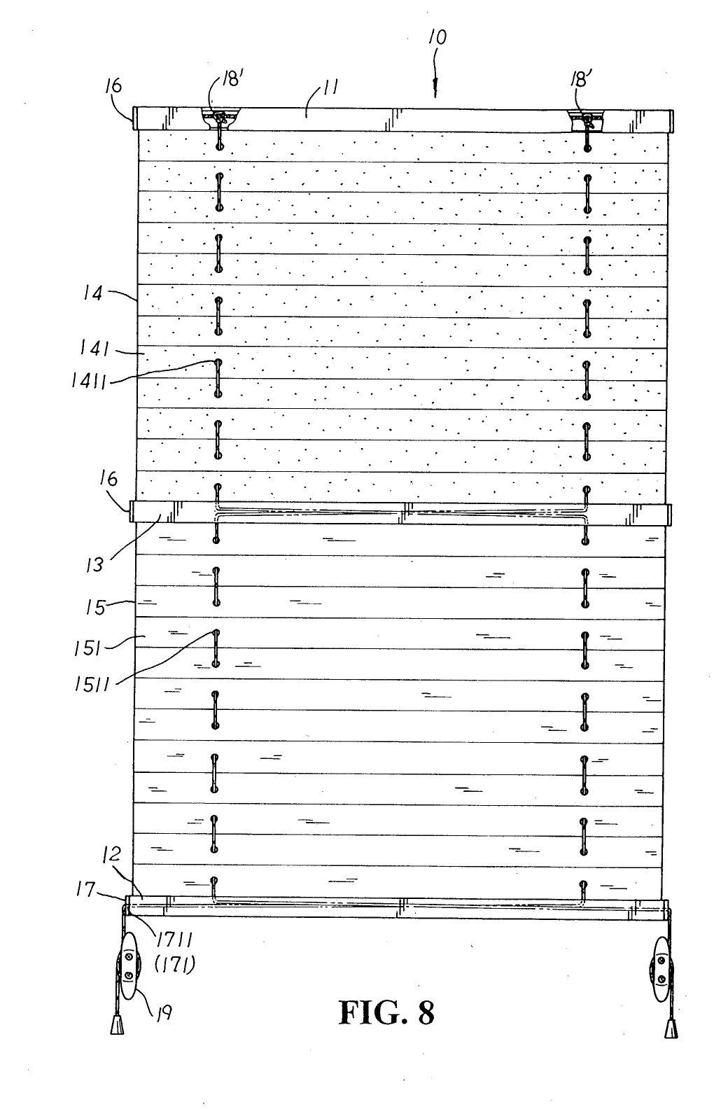

Please refer to FIG. 7. The multi-layered Venetian blind 10 can also have two retaining cords 18′ attached to the left and right sides of the upper beam 11 at one end thereof. The retaining cords 18′ are led downwards through the upper cord-passage holes 1411 of the upper slats 141 thereof at the other end and crisscrossed at the intermediate beam 13 therein before passed sequentially through the lower cord-passage holes 1511 of the lower slats 151 and crisscrossed again at the lower beam 12′ therein. Both ends of the retaining cords 18′, extending in opposite directions, are led directly through lower slide guide pieces 121′ disposed at the lower surface of the lower beam 12′ to be tied up to the fixing means 19 and suspended downwards under the lower beam 12′ thereof. Otherwise, both ends of the retaining cords 18′ can be crisscrossed and extended transversely at the lower beam 12 therein till passed out of the locating caps 17 stopped at both ends of the lower beam 12. The retaining cords 18′, led through the outer through holes 1711 of the outer slide guide pieces 1711 thereof, is tied up to the fixing means 19 and suspended downwards beneath the lower beam 12 thereof as shown in FIG. 8.

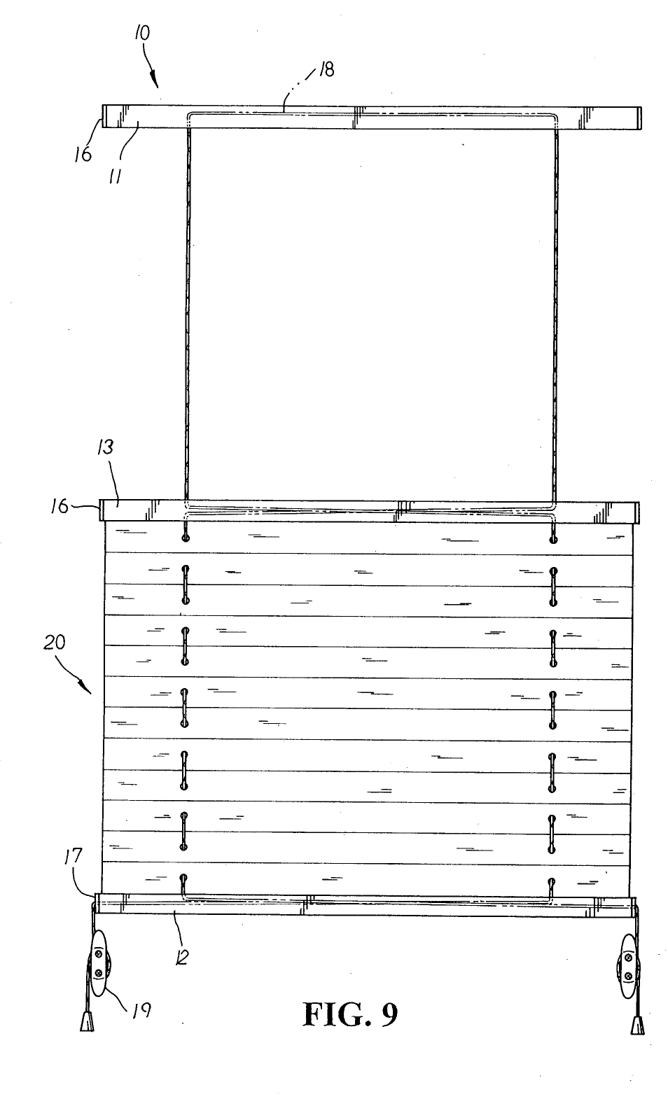

Please refer to FIG. 9. The multi-layer Venetian blind 10 can also have a lower blind body 20 attached at the lower beam 12 and the intermediate beam 13 there-between, and a bare-slat section disposed at the upper beam 11 and the intermediate beam 13 there-between as shown in FIG. 9.

What is claimed is:

1. A non-pull cord operated multi-layer Venetian blind, comprising a multi-layer Venetian blind made up of an upper beam, a lower beam, and an intermediate beam with an upper blind body and a lower blind body of different materials and patterns attached thereto; the present invention being characterized by that,
the upper and lower blind bodies being made up of a plurality of upper and lower slats with upper and lower cord passage holes disposed at both left and right sides of the upper and lower slats thereof respectively;
the upper beam having upper fixing caps adapted at both ends thereof, and a pair of opposite upper slide guide pieces with central through holes disposed at the lower surface thereon; the intermediate beam having intermediate fixing caps adapted at both ends thereof, and opposite intermediate slide guide pieces with central through holes disposed at both upper and lower surfaces thereon respectively; the lower beam having locating caps stopped at both ends thereof, and a pair of opposite lower slide guide pieces with central through holes disposed the upper surface of the lower beam thereof; the locating caps also having outer slide guide pieces with central through hole disposed thereon;
the upper, intermediate, lower, and outer slide guide pieces with through holes disposed at the center thereof respectively having projecting arc facets disposed at the upper and lower inner edges thereof for a retaining cord to be led smoothly there-through;
in assembly, both ends of the retaining cord led through the upper beam for location thereto are guided downwards through the upper cord-passages holes thereof to be crisscrossed and extended in opposite directions at the intermediate beam therein before led sequentially downwards through the lower cord-passages holes to be crisscrossed and extended in opposition directions again at the lower beam therein; finally, both ends of the retaining cord is led through the outer slide guide pieces of the locating caps thereof to be tied up to fixing means and suspended downwards beneath the lower beam thereof;
whereby, via the upper, intermediate, lower, and outer slide guide pieces thereof, the retaining cord is smoothly guided with turning points thereof in sliding abutment against the projecting arc facets thereof so as to reduce the frictional coefficient of each turning point thereof when the Venetian blind thereof is repeatedly pushed upwards or drawn downwards, ensuring the smooth operation of the non-pull cord multi-layer Venetian blind thereof.

2. The non-pull cord operated multi-layer Venetian blind as claimed in claim 1 wherein the lower beam can also have opposite lower slide guide pieces disposed at both upper and lower surfaces thereof wherein both ends of the retaining cord crisscrossed and extended in opposite directions at the lower beam therein are directly led through the lower slide guide pieces disposed at the lower surface thereof to be securely tied up to fixing means and suspended under the lower beam thereof.

3. The non-pull cord operated multi-layer Venetian blind as claimed in claim 1 wherein two retaining cords can also be adapted and attached to left and right sides of the upper beam at one end thereof respectively.

4. The non-pull cord operated multi-layer Venetian blind as claimed in claim 1 wherein the multi-layer Venetian blind can also have a lower blind body attached at the lower beam and the intermediate beam there-between, and a bare-slat section disposed at the upper beam and the intermediate beam there-between.
